(19) United States
(12) Patent Application Publication
(10) Pub. No.: US 2014/0355036 A1
(43) Pub. Date: Dec. 4, 2014

(54) PRINTING APPARATUS, TERMINAL APPARATUS, AND NON-TRANSITORY COMPUTER READABLE RECORDING MEDIUM STORED WITH PRINTING PROGRAM

(71) Applicant: KONICA MINOLTA, INC., Chiyoda-ku (JP)

(72) Inventor: Kouichirou MATSUSHITA, Hino-shi (JP)

(73) Assignee: KONICA MINOLTA, INC., Chiyoda-ku (JP)

(21) Appl. No.: 14/289,965

(22) Filed: May 29, 2014

(30) Foreign Application Priority Data
Jun. 3, 2013 (JP) 2013-117144

(51) Int. Cl. G06F 3/12

(52) U.S. Cl. CPC G06F 3/1243; G06F 3/1215; G06F 3/1256
USPC 358/1.14

(57) ABSTRACT

The printing apparatus which performs printing by replacing print content for each record, generates image data for printing corresponding to one record among a plurality of records based on print data, prints an image corresponding to the one record based on the generated image data using a printing unit, and lists values of the one record on a display unit until an image corresponding to a record following the one record is printed by the printing unit, after an image corresponding to a record prior to the one record is printed by the printing unit.

### CROSS-REFERENCE TO RELATED APPLICATION

This application is based on Japanese Patent Application No. 2013-117144 filed on Jun. 3, 2013, the contents of which are incorporated herein by reference.

### BACKGROUND

1. Technical Field

The present invention relates to a printing apparatus which performs printing by replacing print content for each record, a terminal apparatus, and a non-transitory computer readable recording medium stored with a printing program.

2. Description of Related Arts

For producing printed matter in which a portion of print content thereof is replaced for each addressee in the same way as in direct mail or a credit card statement, so-called variable printing is widely employed. Generally, in the variable printing, mass page printing is performed by referring to a database in which a plurality of records are described, and by replacing a portion of the print content for each record.

Unlike a general commercial printing of performing the mass page printing of one image, the variable printing is to perform the mass page printing of images different from each other for each record, and thus, there is a problem that it is difficult to determine whether or not each page is printed correctly in the variable printing.

In relation to this, Japanese Unexamined Patent Application Publication No. 2006-338569 discloses, when the variable printing is performed, a technology of displaying print preview images of all pages on a display unit, using image data for printing before starting a printing process. According to this technology, a user can confirm the print content by referring to the print preview images which are displayed on the display unit, before a start of the printing process.

However, in this technology, since the print content is confirmed collectively before the start of the printing process, the start of the printing process is delayed. Thus, it is not preferable to use the technology. In the variable printing, it is preferable that the user confirms the print content in real time during execution of the printing process and the printing process can be stopped or a page with an error can be recorded if an error is found in the print content.

### SUMMARY

The present invention is intended to solve the above-described problem. One of the objects of the present invention is to provide a printing apparatus, a terminal apparatus, and a non-transitory computer readable recording medium stored with a printing program, by which a user can confirm print content in real time during execution of a printing process, in variable printing for performing printing by replacing the print content for each record.

To achieve at least one of the aforementioned objects, a printing apparatus reflecting one aspect of the present invention performs printing by replacing print content for each record, and includes a generating unit which generates image data for printing corresponding to one record among a plurality of records, based on print data, a printing unit which prints an image corresponding to the one record based on the image data generated by the generating unit, and a display unit which lists values of the one record until an image corresponding to a record following the one record is printed by the printing unit, after an image corresponding to a record prior to the one record is printed by the printing unit.

Preferably, in the above-described printing apparatus, when the values of the record indicate a specific file, the display unit displays content of the file.

Preferably, in the above-described printing apparatus, the display unit displays together the values of the record and a print preview image of an image corresponding to the record.

Preferably, the above-described printing apparatus further includes a reading unit which reads an image that is printed by the printing unit, and preferably, the display unit displays together the values of the record and an image which is obtained by reading the image corresponding to the record, which is printed by the printing unit, by the reading unit.

Preferably, in the above-described printing apparatus, the display unit displays the values of the record immediately before the image corresponding to the record is printed by the printing unit.

Preferably, in the above-described printing apparatus, the display unit displays the values of the record immediately after the image corresponding to the record is printed by the printing unit.

Preferably, the above-described printing apparatus further includes a reception unit which receives a stop instruction of a printing process performed by the printing unit, and a printing control unit which stops the printing process performed by the printing unit, when the stop instruction is received by the reception unit.

The objects, features, and characteristics of this invention other than those set forth above will become apparent from the description given herein below with reference to preferred embodiments illustrated in the accompanying drawings.

### BRIEF DESCRIPTION OF THE DRAWINGS

FIG. 1 is a block diagram illustrating an entire configuration of a printing system to which a printing apparatus according to an embodiment of the present invention is applied.

FIG. 2 is a block diagram illustrating a schematic configuration of a client terminal.

FIG. 3 is a block diagram illustrating a schematic configuration of a printing apparatus.

FIG. 4 is a view illustrating an example of a database which is used in variable printing.

FIGS. 5A and 5B are views illustrating an example of printed matter produced using variable printing.

FIG. 6 is a flowchart illustrating a sequence of a variable printing process executed by a printing apparatus.

FIG. 7 is a view illustrating an example of a display screen which is displayed on an operation panel.

FIG. 8 is a view illustrating another example of a display screen which is displayed on an operation panel.

FIG. 9 is a view illustrating still another example of a display screen which is displayed on an operation panel.

FIG. 10 is a flowchart illustrating a sequence of a variable printing process according to a modification example 1.

FIG. 11 is a flowchart illustrating a sequence of a variable printing process according to a modification example 2.

### DETAILED DESCRIPTION

The embodiments of this invention will be described below with reference to the accompanying drawings.

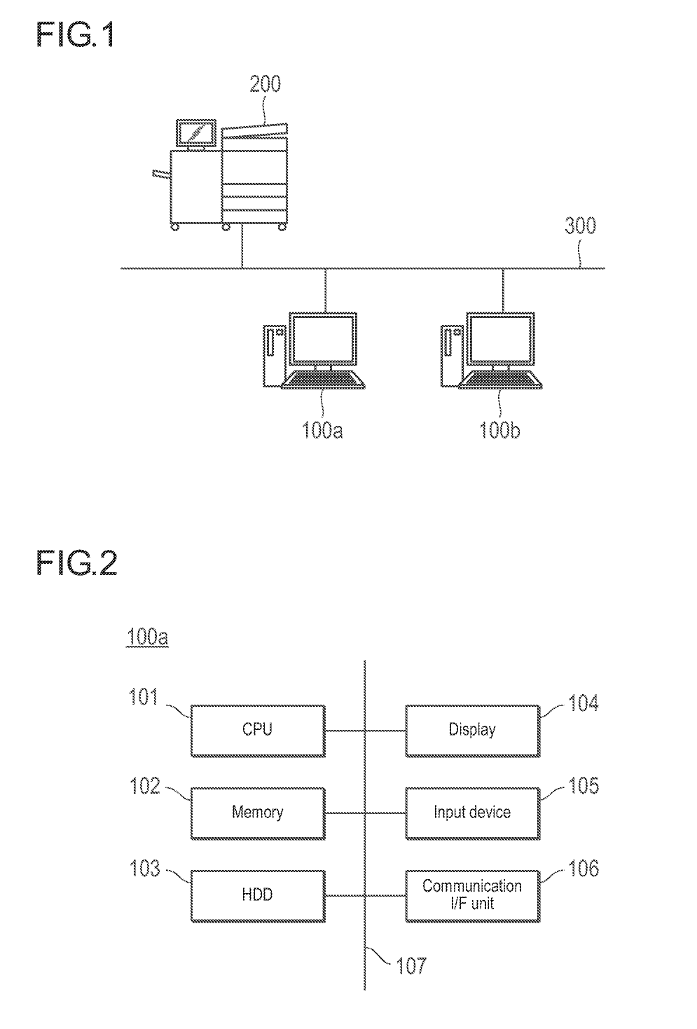

FIG. 1 is a block diagram illustrating an entire configuration of a printing system to which a printing apparatus according to an embodiment of the present invention is applied. The printing system according to the present embodiment includes client terminals 100a and 100b and a printing apparatus 200, and these are connected via a network 300 so as to communicate to each other.

The network 300 is configured with a local area network (LAN) which connects computers to each other or connects between network apparatuses according to a standard such as an Ethernet, a fiber distributed data interface (FDDI), wireless fidelity (Wi-Fi), or a wide area network (WAN) which connects between LANs using a dedicated line. In addition, a type of the apparatuses and the number of the apparatuses which are connected to the network 300 are not limited to the example illustrated in FIG. 1. In addition, the client terminals 100a and 100b and the printing apparatus 200 may be directly connected (local connection) to each other without being connected via the network 300.

FIG. 2 is a block diagram illustrating a schematic configuration of the client terminal 100a. Since the client terminals 100a and 100b are configured in the same way as each other, the client terminal 100a is representatively used in the following description.

The client terminal 100a includes a central processing unit (CPU) 101, a memory 102, a hard disk drive (HDD) 103, a display 104, an input device 105, and a communication interface (I/F) unit 106, and these are connected to each other via a bus 107 for transmitting and receiving signals.

The CPU 101 controls each unit described above and executes various arithmetic processes according to a program. The memory 102 is configured with a read only memory (ROM) in which various programs or various data are previously stored, a random access memory (RAM) which is a work area and in which programs or data are temporarily stored, or the like.

In the HDD 103, various programs including operating system or various data are stored. In the HDD 103, a document file generating application for generating a document file, and a printer driver for converting the document file into print data described by a page description language (PDL) which can be interpreted by the printing apparatus 200, are installed. Here, in the document file generating application, an application for variable printing is included. The application for variable printing uses a standard such as a personalized print markup language (PPML) or portable document format/variable transactional (PDF/VT).

The display 104 is, for example, a liquid crystal display, and displays various information. The input device 105 includes a pointing device such as a mouse, and a keyboard, and is used in performing various inputs.

The communication I/F unit 106 is an interface which communicates with other device via the network 300, and uses a standard such as the Ethernet, the FDDI, or the Wi-Fi.

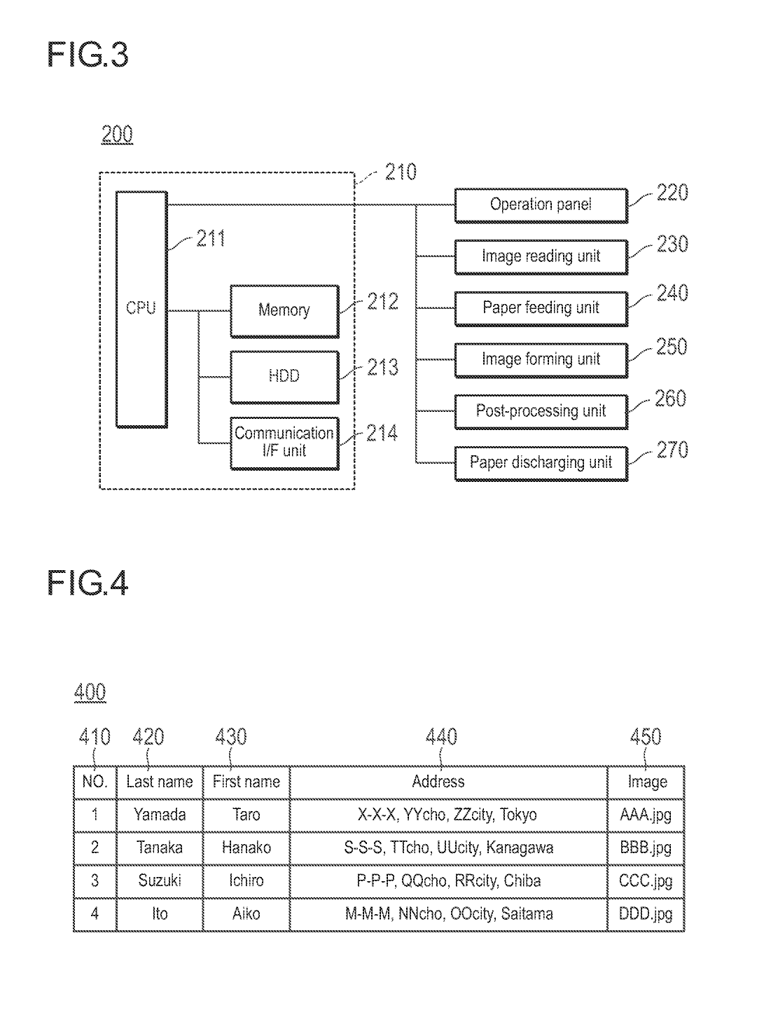

FIG. 3 is a block diagram illustrating a schematic configuration of the printing apparatus 200. The printing apparatus 200 includes a control unit 210, an operation panel 220, an image reading unit 230, a paper feeding unit 240, an image forming unit 250, a post-processing unit 260, and a paper discharging unit 270, and these are connected to each other via a bus for transmitting and receiving signals. Herein, among each unit described above in the printing apparatus 200, the unit having the same function as each unit described above in the client terminal 100a will not be described again so as to avoid duplication of description.

The control unit 210 includes a CPU 211, a memory 212, a HDD 213, and a communication I/F unit 214. In the HDD 213, a program for controlling each unit described above, a program for performing a rasterization process of generating bitmap format image data by interpreting the print data, a program for performing the variable printing of producing printed matter by replacing the print content for each record, and the like are stored.

The CPU 211 functions as a generating unit, a reception unit, and a printing control unit by executing the program stored in the HDD 213. Here, when the variable printing is executed, the generating unit generates the image data for printing corresponding to each record, based on the print data. The reception unit receives a stop instruction of the printing process performed by the image forming unit 250. The printing control unit stops the printing process performed by the image forming unit 250, when the stop instruction of the printing process is received. A specific process content of each unit will be described later.

The operation panel 220 includes a touch panel, a numeric keypad, a start button, a stop button, and the like, and is used for displaying various information and for inputting various instructions. When variable printing is executed, the operation panel 220 lists values of one record until an image corresponding to a record following the one record is printed by the image forming unit 250, after an image corresponding to a record prior to the one record is printed, as a display unit.

The image reading unit 230 exposes an original document set in a predetermined reading position or an original document transported to a predetermined reading position by an auto document feeder (ADF) to light using a light source such as a fluorescent lamp and the like, and photoelectrically converts the resulting reflective light using an imaging device such as a charge coupled device (CCD) image sensor and the like to generate image data from the resulting electrical signal.

The paper feeding unit 240 stores paper to be used as a recording sheet in printing. The paper feeding unit 240 includes a plurality of paper feeding trays, and the paper stored in the paper feeding tray is sent to the image forming unit 250 sheet by sheet.

The image forming unit 250 forms images based on various data on the paper, using a well-known imaging process such as an electrophotography type process including each process of charging, exposing, developing, transferring, and fixing. When the variable printing is executed, the image forming unit 250 prints an image corresponding to each record for each record, as a printing unit.

The post-processing unit 260 performs predetermined post-process to the paper transported from the image forming unit 250. In the post-process, a stapling process, a punching process, a folding process, or the like is included.

The paper discharging unit 270 discharges the printed paper. The paper discharging unit 270 includes a plurality of paper discharging trays, and the printed paper transported from the post-processing unit 260 is discharged in a predetermined paper discharging tray.

In addition, client terminals 100a and 100b and the printing apparatus 200 may include another configuration element other than the above-described configuration elements, or may not include a portion of the above-described configuration elements.

According to the printing system configured as described above, the values of the record are listed on the operation panel 220 of the printing apparatus 200 so as to be synchronized with the printing operation performed by the printing apparatus 200 for each record, in the variable printing of performing the printing by replacing the print content for each record. Hereinafter, an operation of the printing system according to the present embodiment will be described with reference to FIGS. 4 to 11.

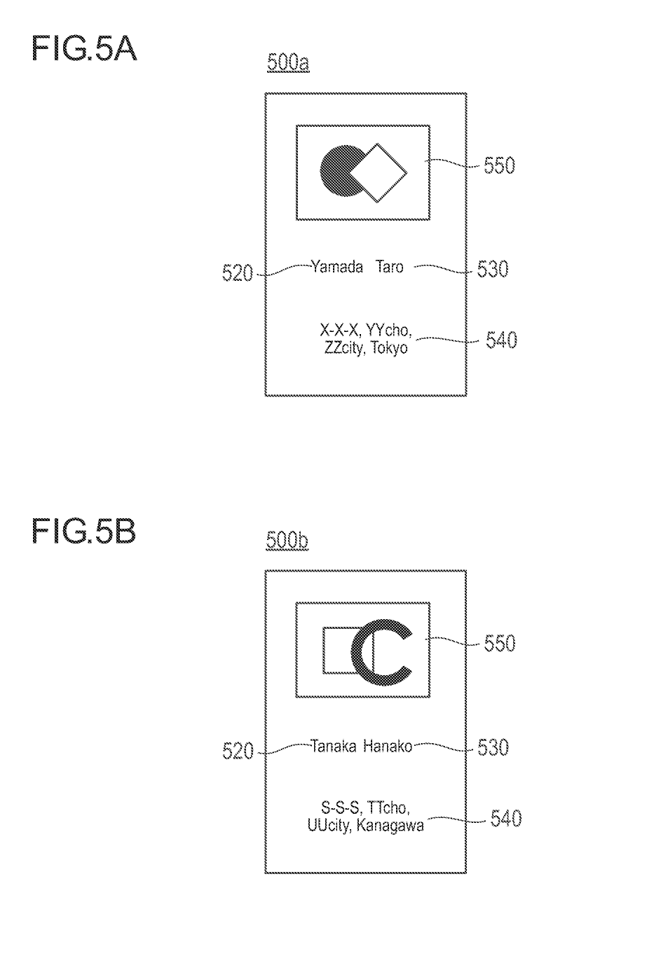

The variable printing will be first described with reference to FIGS. 4, 5A and 5B.

FIG. 4 is a view illustrating an example of a database 400 which is used in the variable printing. As illustrated in FIG. 4, the database 400 includes a record identification information 410, last name information 420, first name information 430, address information 440, and file information 450. The record identification information 410 is information for identifying a plurality of records which are described in the database 400, and the last name information 420, the first name information 430, the address information 440, and the file information 450 are information which indicates the value of each record. In the variable printing, the values of the record which are described in the database 400 are referred to, and the values are replaced for each record.

FIGS. 5A and 5B are views illustrating an example of printed matter produced using variable printing. FIG. 5A is a view illustrating an image 500a corresponding to a record of record identification information “1”, and FIG. 5B is a view illustrating an image 500b corresponding to a record of record identification information “2”.

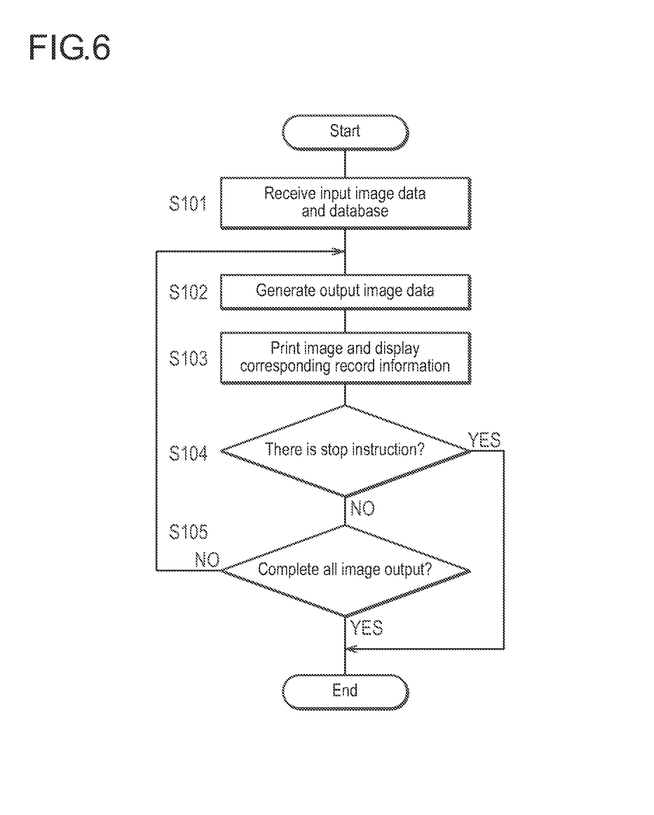

As illustrated in FIGS. 5A and 5B, the images 500a and 500b include last name images 520, first name images 530, address images 540, and file images 550. The last name images 520, the first name images 530, the address images 540, and the file images 550 correspond to the last name information 420, the first name information 430, the address information 440, and the file information 450 in the database 400. In the variable printing, the values (in regard to the file information 450, the file image which is displayed by the file information 450) of each record which are described in the database 400 are combined, and the image corresponding to each record is formed. Hereinafter, an operation of the printing apparatus 200 which executes the variable printing will be described with reference to FIGS. 6 to 11.

FIG. 6 is a flowchart illustrating a sequence of a variable printing process executed by a printing apparatus 200. Herein, an algorithm illustrated in the flowchart of FIG. 6 is stored in the HDD 213 of the printing apparatus 200 as a program and executed by the CPU 211.

Prior to execution of the variable printing process, layout editing in relation to the values of each record is performed in the client terminal 100a. Then, the print data (input image data) for variable printing and the database 400 which is used in the variable printing are transmitted from the client terminal 100a to the printing apparatus 200.

The printing apparatus 200 first receives the input image data and the database (step S101). More specifically, the printing apparatus 200 receives the print data for variable printing which is transmitted from the client terminal 100a and the database 400 in which the plurality of records are described. In addition, the database 400 can be included in the print data.

Next, the printing apparatus 200 generates output image data (step S102). More specifically, the printing apparatus 200 performs the rasterization process for the print data received by the process illustrated in step S101 to generate the image data for printing corresponding to one record.

Next, the printing apparatus 200 prints the image and displays the record information corresponding thereto (step S103). More specifically, the printing apparatus 200 forms the image based on the image data generated by the process illustrated in step S102 on the paper, and reads the values of the record corresponding to the image from the database 400 and then lists the read values on the operation panel 220.

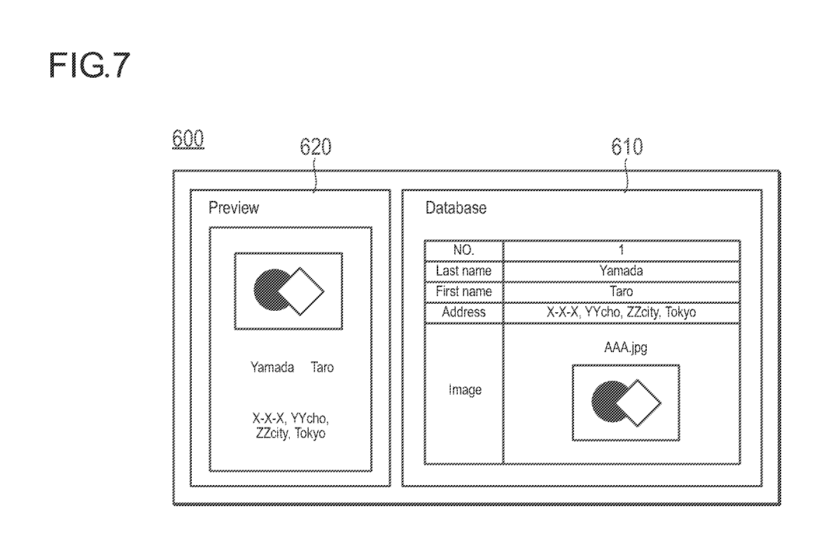

FIG. 7 is a view illustrating an example of a display screen 600 which is displayed on the operation panel 220 of the printing apparatus 200. As illustrated in FIG. 7, the display screen 600 includes a record value display portion 610 and a preview image display portion 620.

The record value display portion 610 lists the values of a record corresponding to an image which is in the process of being printed. The record value display portion 610 displays the record identification information 410, the last name information 420, the first name information 430, the address information 440, and the file information 450 of the one record read from the database 400, in a state where these are not combined. In addition, the record value display portion 610 displays a reduced image of the image of the file indicated by the file information 450 together with the values of the record.

The preview image display portion 620 displays a print preview image of the image which is in the process of being printed. The preview image display portion 620 displays an image based on the image data for printing which is obtained by performing the rasterization process for the print data, or an image which is obtained by combining the print data, as a print preview image.

According to such a configuration, since the values of the record corresponding to the image which is in the process of being printed and the print preview image are displayed on the operation panel 220, a user can confirm the print content in real time, by looking at content of the display screen 600, or by comparing the content of the display screen 600 with the image which is actually printed.

After the image corresponding to one record is printed and the value of this record is listed in the process illustrated in step S103, the printing apparatus 200 determines whether or not there is a stop instruction of the printing process (step S104). More specifically, the printing apparatus 200 determines whether or not the stop instruction of the printing process is received from the user. For example, when finding an error in the values of the record listed on the operation panel 220, or finding a difference between the image actually printed and the values of the record, the user instructs the stop of the printing process.

When it is determined that there is the stop instruction of the printing process (step S104: YES), the printing apparatus 200 ends the process. On the other hand, when it is determined that there is no stop instruction of the printing process (step S104: NO), the printing apparatus 200 determines whether or not the output of all images is completed (step S105). More specifically, the printing apparatus 200 determines whether or not the printing of all the records which are described in the database 400 is completed.

When determining that the output of all images is not completed (step S105: NO), the printing apparatus 200 returns to the process of step S102. Until the output of all the images is completed, the printing apparatus 200 repeats the processes of steps S102 to S105. On the other hand, when determining that the output of all the images is completed (step S105: YES), the printing apparatus 200 ends the process.

As described above, according to the process of the flowchart illustrated in FIG. 6, in the variable printing, the values of the record and the print preview image are displayed on the operation panel 220, so as to be synchronized with the printing operation for each record performed by the image forming unit 250. Thus, during the execution of the printing process, the user can confirm the print content in real time, and when noticing that there is an error in the print content, the user can stop the printing process. In addition, differently from the present embodiment, the user may record the record with an error and later print again only the image corresponding to the record, without stopping the printing process although an error is found.

In addition, according to the present embodiment, since the values of the record and the print preview image are displayed side by side, the user can grasp in which step of the variable printing process with the plurality of steps an abnormality is generated. For example, when there is character corruption in the print preview image while the values of the record are correct, the user can grasp that character corruption occurs due to a loss of font data in the rasterization process. Alternatively, the user can grasp that there is an error in the description itself of the values of the record or a value of the record is not completely fitted inside a character frame during layout editing or a conditional expression for switching the image is incorrect. As a result, time and effort for the user to confirm the process successively retroactively in order to confirm in which step the abnormality occurs are eliminated.

In addition, on the operation panel 220 of the printing apparatus 200, in addition to the values of the record and the print preview image, the read image may be displayed.

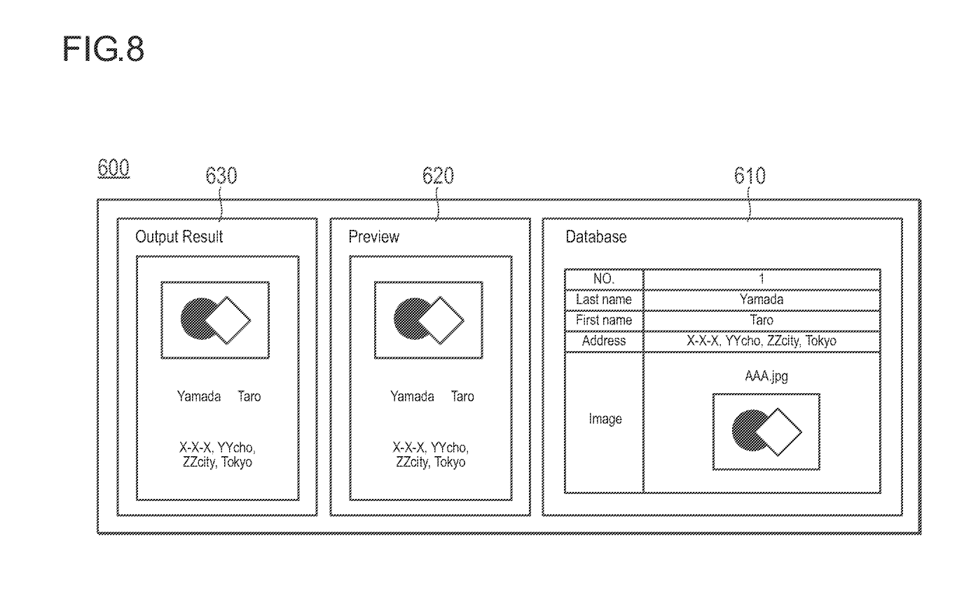

FIG. 8 is a view illustrating another example of a display screen 600 which is displayed on the operation panel 220 of the printing apparatus 200. As illustrated in FIG. 8, the display screen 600 includes the record value display portion 610, the preview image display portion 620, and a read image display portion 630. Herein, since the record value display portion 610 and the preview image display portion 620 are the same as those in FIG. 7, detailed description thereof will not be repeated.

The read image display portion 630 displays the read image of the image printed by the image forming unit 250. More specifically, the image printed by the image forming unit 250 is read by a line sensor (not illustrated) included in the image forming unit 250 or by the image reading unit 230, and the read image display portion 630 displays the image based on the image data which is obtained by reading the printed image.

According to such a configuration, the user can compare the values of the record or the print preview image with the actually printed image, without removing the paper on which the image corresponding to the one record is printed from the paper discharging unit 270 of the printing apparatus 200.

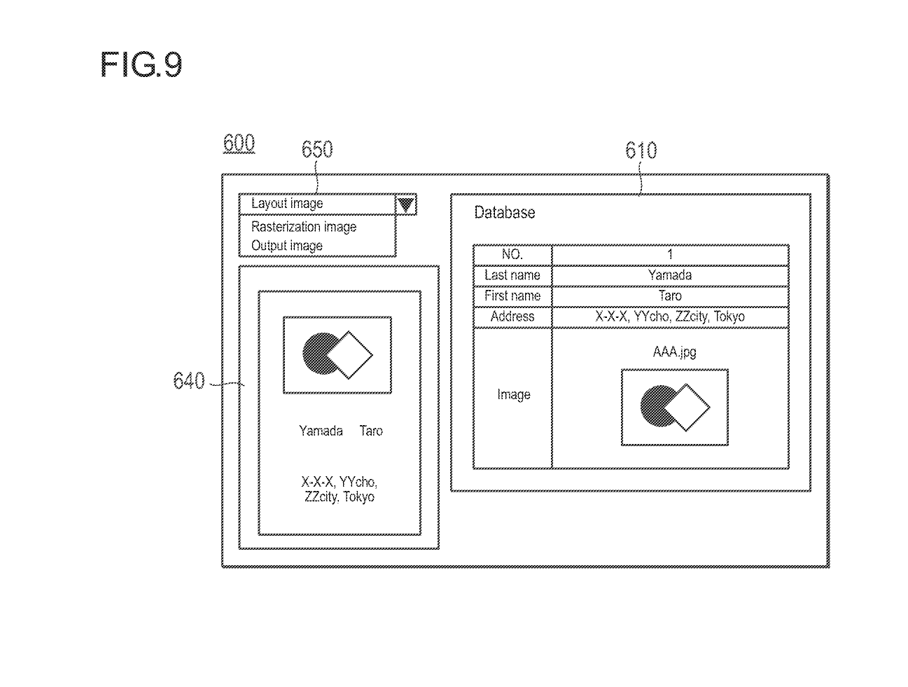

FIG. 9 is a view illustrating still another example of the display screen 600 which is displayed on the operation panel 220 of the printing apparatus 200. As illustrated in FIG. 9, the display screen 600 includes the record value display portion 610, an image display portion 640, and a pull-down box 650. Herein, since the record value display portion 610 is the same as that in FIG. 7, detailed description thereof will not be repeated.

The image display portion 640 displays a print preview image which is obtained by combining the print data, a print preview image based on the image data for printing, or an image which is obtained by reading the printed image.

The pull-down box 650 is used for selecting the image which is displayed on the image display portion 640, among the three images described above.

According to such a configuration, it is possible for the user to freely switch the image used for confirming the print content. In addition, since only one image is displayed on the operation panel 220, it is possible to increase an image size.

### Modification Example 1

In the above-described embodiment, at the same time when the image corresponding to the one record is printed, the values of the record are listed on the operation panel 220. However, after the image corresponding to the one record is printed, the values of the record may be listed on the operation panel 220.

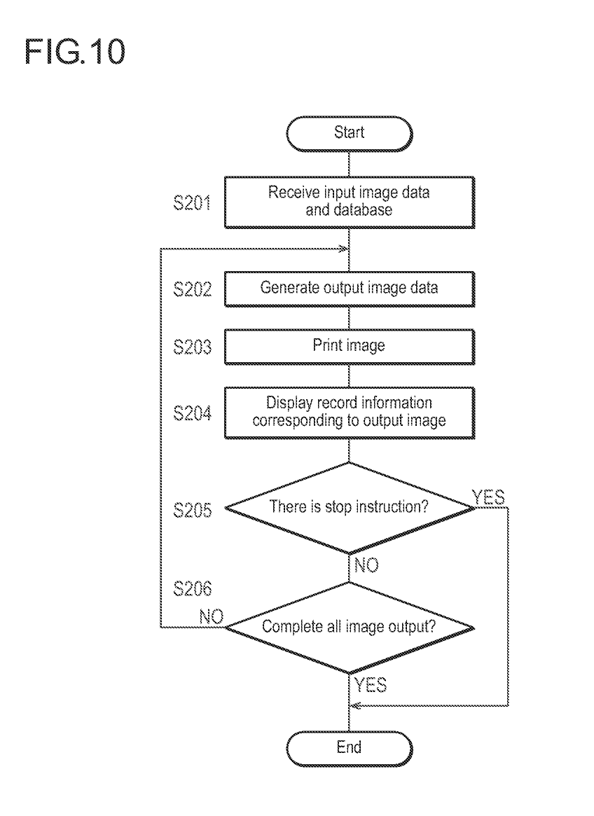

FIG. 10 is a flowchart illustrating a sequence of a variable printing process according to a modification example 1. Herein, an algorithm illustrated in the flowchart of FIG. 10 is stored in the HDD 213 of the printing apparatus 200 as a program and executed by the CPU 211.

Since processes illustrated in steps S201 and S202 are the same as the processes illustrated in steps S101 and S102 of FIG. 6, detailed description thereof will not be repeated.

After the image data for printing is generated in a process illustrated in step S202, the printing apparatus 200 prints the image (step S203). More specifically, the printing apparatus 200 forms the image based on the image data generated by the process illustrated in step S202, on the paper.

Next, the printing apparatus 200 displays record information corresponding to an output image (step S204). More specifically, the printing apparatus 200 lists on the operation panel 220 the values of the record corresponding to the image printed by the process illustrated in step S203, by reading from the database 400.

Since processes illustrated in steps S205 and S206 are the same as the processes illustrated in steps S104 and S105 of FIG. 6, detailed description thereof will not be repeated.

As described above, according to the processes of the flowchart illustrated in FIG. 10, immediately after the image corresponding to the one record is printed, the values of the record are listed on the operation panel 220.

### Modification Example 2

In the present modification example, the values of the record are listed on the operation panel 220, before the image corresponding to the one record is printed.

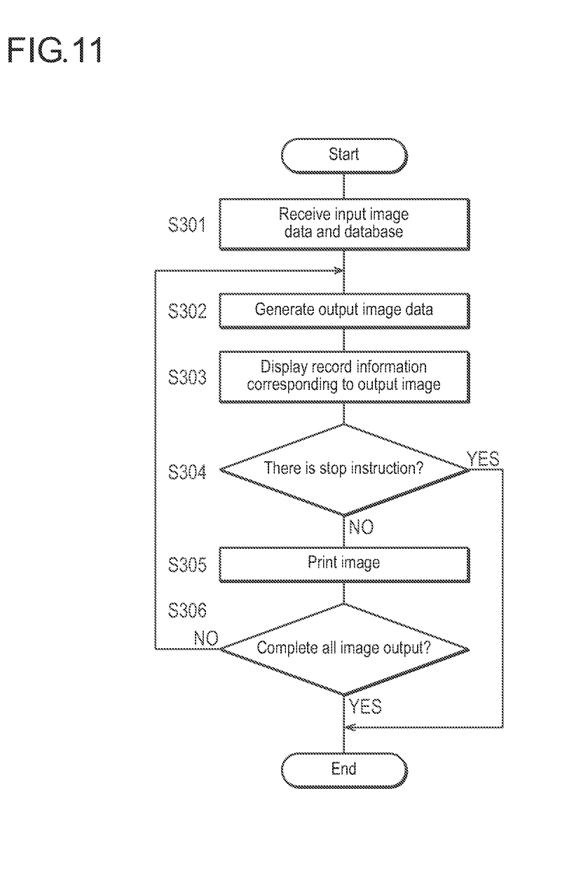

FIG. 11 is a flowchart illustrating a sequence of a variable printing process according to a modification example 2. Herein, an algorithm illustrated in the flowchart of FIG. 11 is stored in the HDD 213 of the printing apparatus 200 as a program and executed by the CPU 211.

Since processes illustrated in steps S301 and S302 are the same as the processes illustrated in steps S101 and S102 of FIG. 6, detailed description thereof will not be repeated.

After the image data for printing is generated in a process illustrated in step S302, the printing apparatus 200 displays the record information corresponding to an output image (step S303). More specifically, the printing apparatus 200 lists on the operation panel 220 the values of the record corresponding to the image data generated by the process illustrated in step S302, by reading from the database 400.

Next, the printing apparatus 200 determines whether or not there is a stop instruction of the printing process (step S304). More specifically, the printing apparatus 200 determines whether or not the stop instruction of the printing process is received from the user.

When it is determined that there is the stop instruction of the printing process (step S304: YES), the printing apparatus 200 ends the process. On the other hand, when it is determined that there is no stop instruction of the printing process (step S304: NO), the printing apparatus 200 prints the image (step S305). More specifically, the printing apparatus 200 forms on the paper the image based on the image data generated by the process illustrated in step S302.

Since a process illustrated in step S306 is the same as the process illustrated in step S105 of FIG. 6, detailed description thereof will not be repeated.

As described above, according to the processes of the flowchart illustrated in FIG. 11, immediately before the image corresponding to the one record is printed, the values of the record are listed on the operation panel 220. According to such a configuration, when there is an error in the values of the record, it is possible to stop the printing process without printing the image corresponding to the record.

The present invention is not limited to the above-described embodiments, and various modifications can be done within the scope of the appended claims.

For example, in the above-described embodiments, the values of the record and the print preview image are displayed on the operation panel 220 of the printing apparatus 200. However, only the values of the record may be displayed on the operation panel 220 of the printing apparatus 200.

In addition, in the above-described embodiments, the values of the record are listed on the operation panel 220 of the printing apparatus 200. However, the values of the record may be listed on a display of a terminal apparatus such as the client terminal 100a or 100b. In this case, for example, the client terminal 100a acquires the values of one record from the printing apparatus 200 or the like, and lists the acquired values on the display 104. Then, the client terminal 100a receives the stop instruction of the printing process, and the client terminal 100a receiving the stop instruction instructs the printing apparatus 200 to stop the printing process. Herein, the CPU 101 of the client terminal 100a functions as an acquisition unit which acquires the values of the record, a reception unit which receives the stop instruction of the printing process, and a printing instruction unit which instructs the printing apparatus 200 to stop the printing process.

The units and the method which perform the various processes in the printing system according to the above-described embodiments can be realized by either a dedicated hardware circuit or a programmed computer. For example, the above-described program may be provided by a non-transitory computer readable recording medium such as a flexible disk or a CD-ROM, or may be provided by an online service via a network such as the Internet. In this case, the program stored in the non-transitory computer readable recording medium is usually transferred to a storage unit such as a HDD and then stored therein. In addition, the above-described program may be provided as independent application software, or may be incorporated in a software of a device as a function of the printing system.

What is claimed is:

1. A printing apparatus which performs printing by replacing print content for each record, comprising:
a generating unit which generates image data for printing corresponding to one record among a plurality of records, based on print data;
a printing unit which prints an image corresponding to the one record based on the image data generated by the generating unit; and
a display unit which lists values of the one record until an image corresponding to a record following the one record is printed by the printing unit, after an image corresponding to a record prior to the one record is printed by the printing unit.

2. The printing apparatus as claimed in claim 1, wherein
when the values of the record indicate a specific file, the display unit displays content of the file.

3. The printing apparatus as claimed in claim 1, wherein
the display unit displays together the values of the record and a print preview image of an image corresponding to the record.

4. The printing apparatus as claimed in claim 1, further comprising:
a reading unit which reads an image that is printed by the printing unit,
wherein the display unit displays together the values of the record and an image which is obtained by reading the image corresponding to the record, which is printed by the printing unit, by the reading unit.

5. The printing apparatus as claimed in claim 1, wherein
the display unit displays the values of the record immediately before the image corresponding to the record is printed by the printing unit.

6. The printing apparatus as claimed in claim 1, wherein
the display unit displays the values of the record immediately after the image corresponding to the record is printed by the printing unit.

7. The printing apparatus as claimed in claim 1, further comprising:
a reception unit which receives a stop instruction of a printing process performed by the printing unit; and
a printing control unit which stops the printing process performed by the printing unit, when the stop instruction is received by the reception unit.

8. A terminal apparatus which can communicate with a printing apparatus that performs printing by replacing print content for each record, comprising:
an acquisition unit which acquires values of one record among a plurality of records; and
a display unit which lists the values of the one record acquired by the acquisition unit until an image corresponding to a record following the one record is printed by a printing unit of the printing apparatus, after an image corresponding to a record prior to the one record is printed by the printing unit.

9. The terminal apparatus as claimed in claim 8, wherein
when the values of the record indicate a specific file, the display unit displays content of the file.

10. The terminal apparatus as claimed in claim 8, wherein
the display unit displays together the values of the record and a print preview image of an image corresponding to the record.

11. The terminal apparatus as claimed in claim 8, wherein
the display unit displays together the values of the record and an image which is obtained by reading the image corresponding to the record, which is printed by the printing unit, by a reading unit of the printing apparatus.

12. The terminal apparatus as claimed in claim 8, wherein
the display unit displays the values of the record immediately before the image corresponding to the record is printed by the printing unit.

13. The terminal apparatus as claimed in claim 8, wherein
the display unit displays the values of the record immediately after the image corresponding to the record is printed by the printing unit.

14. The terminal apparatus as claimed in claim 8, further comprising:
a reception unit which receives a stop instruction of a printing process performed by the printing unit; and
a printing instruction unit which instructs a stop of the printing process performed by the printing unit, when the stop instruction is received by the reception unit.

15. A non-transitory computer readable recording medium stored with a printing program, which is executed in a printing apparatus that performs printing by replacing print content for each record, the program causing the printing apparatus to execute a process comprising the steps of:
(a) generating image data for printing corresponding to one record among a plurality of records, based on print data; and
(b) printing an image corresponding to the one record based on the image data generated in step (a), using a printing unit, and listing values of the one record on a display unit until an image corresponding to a record following the one record is printed by the printing unit, after an image corresponding to a record prior to the one record is printed by the printing unit.

16. The non-transitory computer readable recording medium as claimed in claim 15, wherein
when the values of the record indicate a specific file, content of the file is displayed on the display unit in step (b).

17. The non-transitory computer readable recording medium as claimed in claim 15, wherein
in step (b), the values of the record are displayed on the display unit together with a print preview image of an image corresponding to the record.

18. The non-transitory computer readable recording medium as claimed in claim 15, wherein
in step (b), the values of the record are displayed on the display unit together with an image which is obtained by reading the image corresponding to the record, which is printed by the printing unit, by a reading unit.

19. The non-transitory computer readable recording medium as claimed in claim 15, wherein
in step (b), the values of the record are displayed on the display unit immediately before the image corresponding to the record is printed by the printing unit.

20. The non-transitory computer readable recording medium as claimed in claim 15, wherein
in step (b), the values of the record are displayed on the display unit immediately after the image corresponding to the record is printed by the printing unit.

21. The non-transitory computer readable recording medium as claimed in claim 15, the process further comprising the steps of:
(c) receiving a stop instruction of a printing process performed by the printing unit; and
(d) stopping the printing process performed by the printing unit, when the stop instruction is received in step (c).
